(19) United States
(12) Patent Application Publication
(10) Pub. No.: US 2005/0278640 A1
(43) Pub. Date: Dec. 15, 2005

(54) System and method of dynamic entitlement

(76) Inventors: Edwin R. Jones, Columbia, SC (US); Paul Manning, Columbia, SC (US); John M. Broughton, Lexington, SC (US); Paul R. Gottshall JR., Irmo, SC (US); Darrell L. McDaniel, Columbia, SC (US); Phil Ehlen, Sumter, SC (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/068,568

(22) Filed: Feb. 28, 2005

Related U.S. Application Data
(60) Provisional application No. 60/578,394, filed on Jun. 9, 2004.

(51) Int. Cl. G06F 3/00

(52) U.S. Cl. 715/741

(57) ABSTRACT

A method for creating a user interface for a system may include dynamically assessing entitlement of a user to data elements and/or processes of the system based at least on a security setting of the user and a context of the transaction between the user and the system, authorizing the user to access portions of the system, and filtering a response message of the system based at least on the authorization of the user. The user interface may be rendered based at least on the filtered response message to allow the user to access some portions of the system and to inhibit the user from accessing other portions of the system. A system may include a CPU and a memory coupled to the CPU including program instructions executable to implement the method described above. A carrier medium may include program instructions executable to implement the method described above.

### PRIORITY CLAIM

This application claims priority to U.S. Provisional Patent Application Ser. No. 60/578,394, filed on Jun. 9, 2004; entitled “System and Method of Dynamic Entitlement.”

### BACKGROUND

1. Field of the Invention

The present invention generally relates to computer systems used for various applications, including insurance and/or financial services applications. In particular, embodiments relate to systems and methods of software logic and definitions required to support personalization and data privacy by identifying a user and dynamically changing a user interface to only expose the features and/or data to which a user is entitled.

2. Description of Related Art

U.S. patent application Publication No. 2003/0093672 to Chicowlas, which is incorporated by reference herein, describes a system and associated methods for administration of access control to numerous resources and objects. U.S. patent application Publication No. 2003/0191703 to Chen et al., which is incorporated by reference herein, describes a system and methods for allowing a client to specify various levels of access permission for an interested party, and thereby to control the level of detail accessible by one or more interested parties using the system.

U.S. patent application Publication No. 2004/0003347 to Saidenberg et al., which is incorporated by reference herein, describes a system and method for determining a set of applications that can be accessed by a group or constituency of entitled users from among the applications associated with a server system. The system may provide a common look and feel for the applications accessed by a particular group or constituency based on an identification subentity code.

U.S. patent application Publication No. 2004/0044895 to Reasons et al., which is incorporated by reference herein, describes an entitlement system and method for computers allowing controlled access to operating systems, software applications, data, or hardware for a computer system. More particularly, the entitlement system involves localized control to access computer operations, including operating systems, software, internet access, data, hardware, or the like, which may be updated remotely.

### SUMMARY

In an embodiment, a method for creating a user interface for a system may include identifying a user of the system, assessing a security setting of the user, and assessing context within a transaction between the user and the system. The method may include assessing entitlement of the user to portions of the system based at least partially on the security setting of the user and the context of the transaction between the user and the system. Some embodiments may include authorizing the user to access portions of the system to which the user is entitled. Certain embodiments may include filtering a response message of the system based at least partially on the authorization of the user. The user interface may be rendered based at least in part on the security setting of the user to allow the user to access one or more of the portions of the system that the user is authorized to access and to inhibit the display of one or more portions of the system that the user is not authorized to access.

In some embodiments, a system may include a CPU and a memory coupled to the CPU. The memory coupled to the CPU may include program instructions executable to implement the method described herein for creating a user interface for the system. In some embodiments, a carrier medium may include program instructions executable to implement the method described herein for creating a user interface for the system.

### BRIEF DESCRIPTION OF THE DRAWINGS

A better understanding of the present invention may be obtained when the following detailed description of embodiments is considered in conjunction with the following drawings, in which:

FIG. 1 depicts an embodiment of architecture of a system with zones, tiers, and layers.

FIG. 2 depicts an embodiment of tier architecture of a system.

FIG. 3 illustrates an embodiment of a method of dynamically creating a user interface for a system.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

Information may be managed between a user system and a processing system. For example, insurance policies may be managed between a user system and an insurance claim processing system. A user system may be coupled to a processing system. Wires, wide area networks (“WAN”), local area networks (“LAN”), and combinations thereof may couple a user system and a processing system. A WAN may be a network that spans a relatively large geographical area. The Internet is an example of WAN. A WAN may include a variety of heterogeneous computer systems and networks that may be interconnected in a variety of ways and that may run a variety of software applications.

One or more LANs may be coupled to a WAN. A LAN may be a network that spans a relatively small area compared to a WAN. A LAN may be confined to a single building or group of buildings. Each node (e.g., user system, individual computer system or device) on a LAN may have its own CPU with which it may execute programs, and each node may also be able to access data and devices anywhere on a LAN. A LAN may allow many users to share devices (e.g., printers) and data stored on file servers. A LAN may be characterized by a variety of types of topology (e.g., the geometric arrangement of devices on the network), of protocols (e.g., the rules and encoding specifications for sending data, and whether the network uses a peer-to-peer or user/server architecture), and of media (e.g., twisted-pair wire, coaxial cables, fiber optic cables, and/or radio waves). A LAN may be coupled to other computer systems and/or other devices and/or other LANs through a WAN.

One or more mainframe computer systems may be coupled to a WAN. A mainframe may be coupled to a storage device or file server and mainframe terminals. A processing system may include a combination of mainframes and/or mainframe terminals. Mainframe terminals may access data stored in the storage device or file server coupled to or included in mainframe computer system. A user system may be a mainframe terminal.

A WAN may also include computer systems (e.g., user systems, insurance claim processing systems, etc.) connected to a WAN individually and not through a LAN. For example, WAN may include computer systems that may be geographically remote and connected to each other through the Internet.

A computer system (e.g., user systems, insurance claim processing systems, etc.) may also include a display device such as monitor, an alphanumeric input device such as keyboard, and a directional input device such as mouse. A computer system may typically include components such as CPU with an associated memory such as floppy disks and/or CD-ROMs. Memory may store program instructions for computer programs. Program instructions may be executable by CPU. The term “memory” is intended to include any installation medium, e.g., a CD-ROM or floppy disks, a computer system memory such as DRAM, SRAM, EDO RAM, Rambus RAM, etc., or any non-volatile memory such as a magnetic media, e.g., a hard drive or optical storage. Memory may also include other types of memory or combinations thereof. In addition, memory may be located in a first computer, which executes the programs or may be located in a second different computer, which connects to the first computer over a network. In the latter instance, the second computer may provide the program instructions to the first computer for execution. A computer system may take various forms such as a personal computer system, mainframe computer system, workstation, network appliance, Internet appliance, personal digital assistant (“PDA”), television system or other device. In general, the term “computer system” may refer to any device having a processor that executes instructions from a memory.

Computer systems may be operable to execute computer programs to implement computer-implemented systems (hereinafter “systems”). It may be desirable to utilize a system for processing (e.g., insurance claim processing) which is configured to be accessed over the Internet or through a web browser, including those described in the following applications, which are incorporated by reference herein:

U.S. patent application Ser. No. 09/699,021 to Bobbitt et al., entitled “CONFIGURING DYNAMIC DATABASE PACKAGE SET SWITCHING FOR USE IN PROCESSING BUSINESS TRANSACTIONS”, filed Oct. 27, 2000;

U.S. patent application Ser. No. 09/699,058 to Doughty et al., entitled “PROCESSING BUSINESS TRANSACTIONS USING DYNAMIC DATABASE PACKAGE SET SWITCHING”, filed Oct. 27, 2000;

U.S. patent application Ser. No. 09/699,056 to Doughty, entitled “PROCESSING BUSINESS DATA USING USER-CONFIGURED KEYS”, filed Oct. 27, 2000;

U.S. patent application Ser. No. 09/699,037 to Doughty, entitled “CONFIGURING KEYS FOR USE IN PROCESSING BUSINESS DATA”, filed Oct. 27, 2000;

U.S. patent application Ser. No. 09/603,307 to Childress et al., entitled “SYSTEM AND METHOD FOR PROCESSING INSURANCE CLAIMS USING A TABLE OF CONTENTS” filed on Jun. 23, 2000;

U.S. patent application Ser. No. 09/603,129 to Jones, entitled “SYSTEM AND METHOD FOR IDENTIFYING CRITICAL FACTORS AFFECTING AN ESTIMATED VALUE INCLUDED IN AN INSURANCE CLAIM CONSULTATION REPORT” filed on Jun. 23, 2000;

U.S. patent application Ser. No. 09/603,662 to Childress, entitled “RELEVANCE CALCULATION FOR A REFERENCE SYSTEM IN AN INSURANCE CLAIMS PROCESSING SYSTEM” filed on Jun. 23, 2000;

U.S. patent application Ser. No. 09/603,308 to Wolfe et al., entitled “SYSTEM AND METHOD FOR EXTERNALIZATION OF FORMULAS FOR ASSESSING DAMAGES” filed on Jun. 23, 2000;

U.S. patent application Ser. No. 09/603,144 to Jones et al., entitled “SYSTEM AND METHOD FOR EXTERNALIZATION OF RULES FOR ASSESSING DAMAGES” filed on Jun. 23, 2000;

U.S. patent application Ser. No. 09/602,687 to Lorenz, entitled “WEB-ENABLED SYSTEM AND METHOD FOR ASSESSING DAMAGES” filed on Jun. 23, 2000;

PCT Patent Application No. PCT/US01/20030 to Jones et al., entitled “SYSTEM AND METHOD FOR PROCESSING INSURANCE CLAIMS” filed on Jun. 21, 2001;

U.S. patent application Ser. No. 09/603,302 to Childress, entitled “DYNAMIC HELP SYSTEM FOR AN INSURANCE CLAIMS PROCESSING SYSTEM” filed on Jun. 23, 2000;

U.S. patent application Ser. No. 09/602,691 to Childress, entitled “GRAPHICAL USER INTERFACE WITH A HIDE/SHOW FEATURE FOR A REFERENCE SYSTEM IN AN INSURANCE CLAIMS PROCESSING SYSTEM” filed on Jun. 23, 2000;

U.S. patent application Ser. No. 09/603,130 to Lorenz, entitled “RESET BUTTON FOR WEB-ENABLED SYSTEM AND METHOD FOR ASSESSING DAMAGES” filed on Jun. 23, 2000;

U.S. patent application Ser. No. 09/603,303 to Lorenz, entitled “INTERNET-ENABLED SYSTEM AND METHOD FOR ASSESSING DAMAGES” filed on Jun. 23, 2000;

U.S. patent application Ser. No. 09/603,304 to Lorenz, entitled “PRICING MODELS FOR WEB-ENABLED SYSTEM AND METHOD FOR ASSESSING DAMAGES” filed on Jun. 23, 2000;

U.S. patent application Ser. No. 09/603,306 to Wolfe, entitled “SYSTEM AND METHOD FOR DISPLAYING MESSAGES USING A MESSAGES TABLE” filed on Jun. 23, 2000;

U.S. patent application Ser. No. 10/422,632 to Wahlbin, entitled “GRAPHICAL INPUT DISPLAY IN AN INSURANCE PROCESSING SYSTEM” filed on Apr. 24, 2003;

U.S. Patent Application Publication No. 2004-0054557 published on Mar. 18, 2004 to Wahlbin et al., entitled “COMPUTERIZED METHOD AND SYSTEM FOR ESTIMATING PREMISES LIABILITY FOR AN ACCIDENT” filed on Sep. 9, 2002;

U.S. patent application Publication No. 2002-0069091 published on Jun. 6, 2002 to Wahlbin et al., entitled “COMPUTERIZED METHOD OF LIABILITY ASSESSMENT FOR AN ACCIDENT” filed on Oct. 2, 2001;

U.S. Patent Application Publication No. 2004-0088196, published on May 6, 2004, to Childress et al., entitled “GRAPHICAL DISPLAY OF BUSINESS RULES” filed on Oct. 31, 2002;

U.S. patent application Ser. No. 10/306,864 to Wahlbin et al., entitled “COMPUTERIZED METHOD AND SYSTEM FOR ESTIMATING LIABILITY FOR AN ACCIDENT FROM AN INVESTIGATION OF THE ACCIDENT,” filed on Nov. 27, 2002;

U.S. patent application Ser. No. 10/790,632 to Woods et al., entitled “SYSTEMS AND METHODS FOR A GRAPHICAL INPUT DISPLAY IN AN INSURANCE PROCESSING SYSTEM,” filed on Mar. 1, 2004;

U.S. patent application Ser. No. 10/306,864 to Lorenz, entitled “SYSTEMS AND METHODS FOR USING DATA STRUCTURE LANGUAGE IN WEB SERVICES,” filed on Mar. 1, 2004;

U.S. patent application Ser. No. 10/786,572 to Osborne, entitled “SYSTEMS AND METHODS FOR PRINTING AN INSURANCE DOCUMENT,” filed on Feb. 25, 2004;

U.S. patent application Ser. No. 10/306,864 to Lorenz, entitled “SYSTEMS AND METHODS FOR USING DATA STRUCTURE LANGUAGE IN WEB SERVICES,” filed on Mar. 1, 2004; and

U.S. patent application Ser. No. XXX to Van Hutten et al., entitled “SYSTEM AND METHOD FOR CAPTURING AN IMAGE,” filed on May 3, 2004.

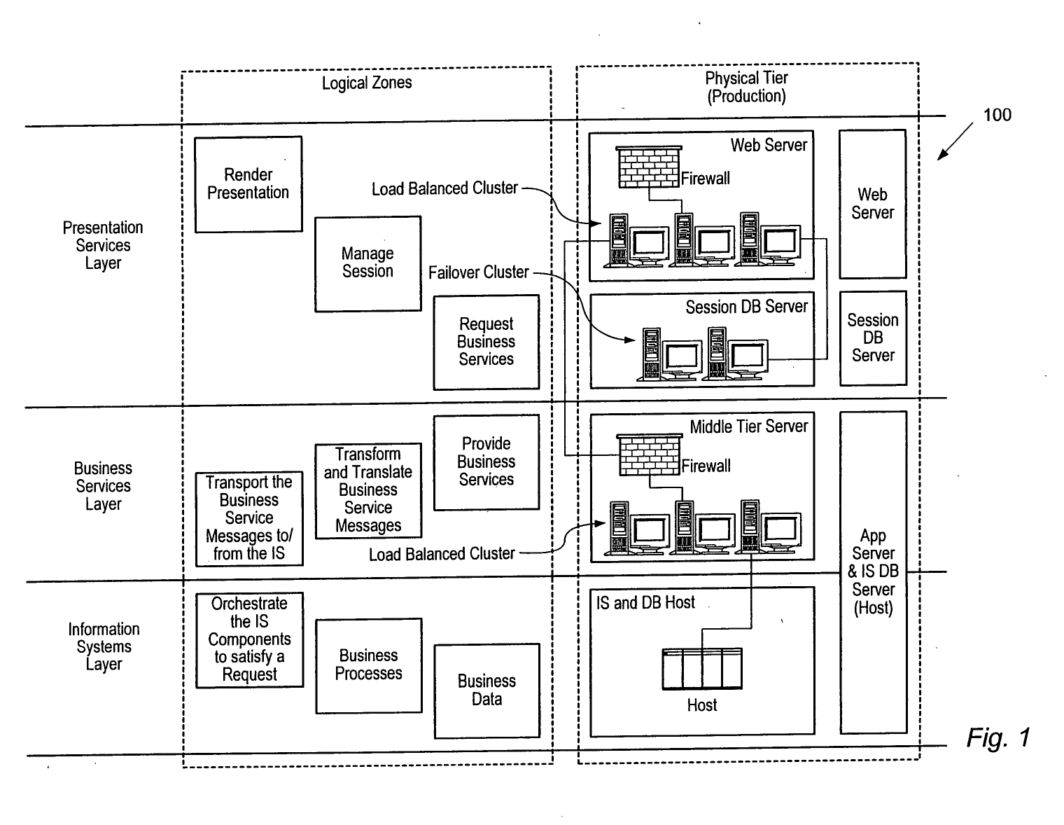

In some embodiments, architecture of a system may be expressed in terms of layers (e.g., logical services and related resources), zones (e.g., functional services per layer), and/or tiers (e.g., physical resources per layer). FIG. 1 depicts an embodiment of system 100 an architecture including layers, zones, and tiers. Zones may be functional services zones. In certain embodiments, functional services zones are categories of actions taken to achieve a given result. Zones may be responsible for: rendering the presentation of information to the user; managing the user session; requesting a business service; transforming and translating a business service message; transporting the business service message to and from the information service (“IS” in FIG. 1); performing a business process; managing access to business data; and providing results of a business service to a user.

Presentation services zone functions may include business services request initiation and services that present the results of fulfillment of that business service request to appropriate user environments. Business services zone functions may include message transport functions between the presentation services layer and information systems layer, involving adapters for information systems and third party application integration. Information systems zone functions may include, for example, insurance and/or financial components and/or customer legacy systems.

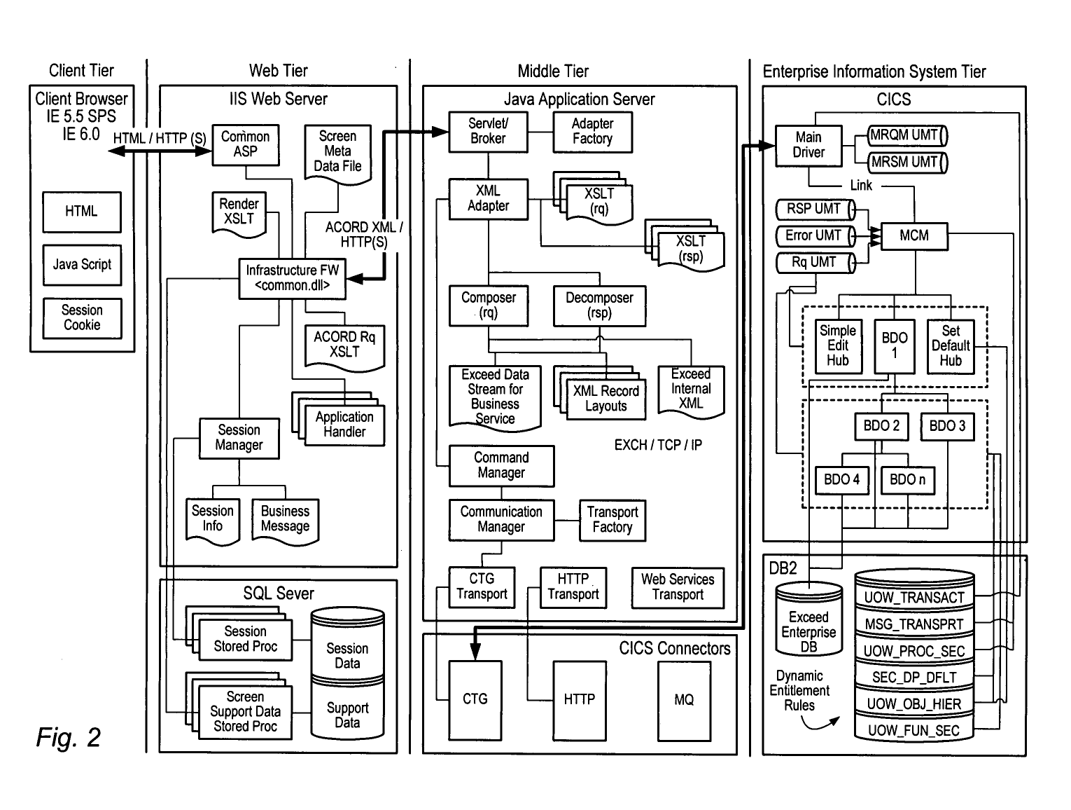

A tier is a physical location for a collection of operational elements. FIG. 2 depicts an embodiment of tier architecture of system 100. Tier components may be described as being in one of three locations: front end tier (presentation services layer, e.g., client tier and web tier); middle tier (business services layer); and host or back-end tier (information systems layer). In some embodiments, tier components may include a web server, session database server, middle tier server, and database host or an application server and database server (host). The presentation services tier may provide web or application server environments. The business services tier may provide an integrative message management server environment. The information systems tier may provide a mainframe processing environment. In some embodiments, a given component (e.g., an application server) may provide support for (e.g., span) more than one physical tier.

In some embodiments, architecture may be divided functionally into two or more (e.g., three) discrete and decoupled logical layers. As used herein, “layer” generally refers to a logical collection of operational elements, identified by processing responsibilities. A layer may encapsulate a given class of logic as well as the technologies used to implement the given class of logic. Logical layers may, for example, render the presentation of information to a user, manage a user session, request a business service, transform and/or translate a business service message, transport a business service message from one layer to another, perform a business process, manage access to business data, and/or provide the results of a business service to the user. Logical layers in a system may include, but are not limited to, a presentation services layer, a business services layer, and an information systems layer.

Each logical layer of a system (e.g., presentation services layer, business services layer, information systems layer) may include a given class of logic and may encapsulate. technologies used to implement the layer. The logical layers may therefore be coupled with flexibility to allow changes to one layer without requiring changes to another layer. A request/response message pair (e.g., a transaction) with processing centered in the business services layer, may couple the layers. In some embodiments, the business service messages may convey data elements and relationships, as well as metadata attributes associated with the data elements and relationships. This message structure may allow for distributed processing without requiring logic from one layer to be implemented in another layer.

A presentation services layer may be responsible for the user interface (e.g., human or machine facing). In some embodiments, the presentation services layer may manage a user session and/or render a presentation (e.g., display). The presentation services layer may provide a front end that communicates a business services request (e.g., process a claim, establish a client, rate a policy) to a message translation service of the business services layer and to the business logic in the information systems layer. The presentation services layer may present a response message from the business services layer to a given user interface. In some embodiments, ACORD XML messages may provide the services request and response transport medium between the presentation services layer and the business services layer.

A business service request (“request”) may be contained in a business service XML message. The business service XML message may be a pre-defined message that originates from the presentation layer. The business service XML message may contain a specific request for data or for a process. The request message may be linked to one unit of work. As used herein, “unit of work” (UOW) defines the work that is done to fulfill the business request.

The business services layer transports business services messages to and from the information systems layer. In some embodiments, the business services layer may provide a translation service for messages (e.g., a request from a presentation services layer with ACORD standard message formats, a response from an information systems layer) with message formats appropriate to the business logic that fulfills the business service requirements in the original message. The business services layer may provide a boundary between presentation (e.g., presentation services layer) and processing (e.g., information systems layer) activities. The business services layer may provide an abstract interface to the business functions and data. The business services layer may encapsulate and hide complexities of processing (e.g., insurance processing) while providing a simple, consistent entry point for all business service requests.

A presentation services layer may manage a session associated with a logged-on user and that session's relationship to a business service message. In some embodiments, ACORD-standard XML may be the foundation of the business message. The presentation services layer may provide an engine that infers logic from data associated with the business service XML message without implementing business logic. Browser dialogs may be rendered by the presentation services layer using: eXtensible Stylesheet Language Transformation (XSLT); the business service XML message (including the metadata); and screen meta information (e.g., XML describing the presentation qualities of the business service message's data elements). These features may provide logical decoupling between the presentation services layer and the business services layer, allowing “plug-in” presentation services layers, including those custom created or from a third party.

The information systems layer may contain logic components from various sources. In some embodiments, the information systems layer may include security information. The information systems layer may orchestrate information components to satisfy a request using business processes and business data. In some embodiments, an information systems layer (or tier) may include dynamic entitlement rules (as depicted in FIG. 2).

As used herein, “rendering” is a dynamic process within a system that displays visual information (e.g., on a screen). Rendering may start from an initial description of a screen using one or more parameters. Rendering may transform parameters into a visual representation (e.g., a display). In certain embodiments, rendering may be influenced by an identity, a role, and/or a security setting of a user. In some embodiments, a security setting of a user may be based on the security group to which the user belongs and the unit of work associated with a request to the business services layer. As used herein, a “security setting” of a user generally refers to the user's access rights as determined by, for example, the information systems layer of a system. In some embodiments, a system may include security to provide user interfaces that only expose the features or data to which a given user is entitled. As used herein, “security” generally refers to software logic and definitions required to identify a given user and associate allowable system actions with that user.

Authorization is the process of confirming that a user is valid within the system and that the user has been granted access to the requested task or data. Authorization may be divided into categories including, but not limited to, access security, function security, and data security.

Access security is the process of confirming that a user has permission to perform the requested task. In multi-user systems, an administrator may define the users that are allowed access to the system and authorities/privileges of use. Authorization may occur for every business service request. A system may verify that a user has authority to execute each transaction invoked.

In some embodiments, the information systems layer may handle access security. A user ID may be authorized through two levels of security. The first level may confirm that the user ID is valid. If the user is valid, a second level may verify that the user is authorized to execute the business service transaction. In certain embodiments, validity of a user is determined by checking the user ID of the logged-on user against security tables. Security processing may then determine an authority level of the logged-on user and an association type for a requested unit of work by using, for example, another security table. The information systems layer may use the security tables to determine the logged-on user's access rights when executing a unit of work.

In some embodiments, function security processing may provide a means to furnish information to the presentation services layer indicating the actions and/or functions that should be made available to the logged-on user in association with the requested unit of work. Such information may control the presence or absence of page elements, such as links and push buttons, on a rendered page. Entries in a security table may determine the availability of links and push buttons based on unit of work, security group, user ID, processing context, etc. The security table entries may provide a means of controlling the functions the user can access and the tasks the user can perform.

Data security refers to the security applied to the data on each page accessed. Applying security to the data on a page may include limiting what a user can see, limiting what the user can enter, or limiting actions the user may perform against the data. Data security may include, but is not limited to, data privacy processing, default processing, customer-defined security profile information, and dynamic entitlement processing.

As used herein, “data privacy processing” involves rules that can prohibit or require viewing or alteration of specific data rows or fields based on customer-specified criteria. These criteria are indicated by mean of column indicator fields. Data privacy is both “outbound” and “inbound.” That is, rules can be executed against the data in both the incoming request message and the outgoing response message. In some embodiments, data privacy may include the ability to limit the availability of any data element in a system to a given user.

As used herein, “default processing” involves rules that define default values for display in selected fields, based on customer-specified criteria. Data is defaulted to the page based on information returned by the business services layer. A “set default” request is sent to the information systems layer to request the default information for the page. Default data may also be returned when data is not found during a fetch request to the information systems layer.

The information systems layer may provide one or more security support tables that enable the creation and storage of customer-defined security profile information based on group ID, user ID, etc. The entries in the security support tables may be defined by the customer. These tables may provide a layer of flexibility in defining and processing security parameters without having to change base code. The tables can be used to streamline drop-down information or to influence other data display factors based on the group ID, user ID, etc.

In some embodiments, data privacy and default processing allow information that indicates how to present a page to a user to be passed to the presentation services layer. The presentation services layer may interpret the information that indicates how to present the page to the user and render the page. Interpretation of the information that indicates how to present the page to the user and the rendering of the page, or the ability of software logic to dynamically change how the user interface will appear and function, is generally referred to herein as “dynamic entitlement.”

In some embodiments, dynamic entitlement may include the ability, based on a security group of a user, to hide fields, links, and/or buttons; hide columns within a table listing; display application buttons on a home page; enable or disable update capability to fields (e.g., view only); provide default data in fields on user entry screens; define required fields; and establish user defaults based on user identity. In certain embodiments, dynamic entitlement may include an application framework that reduces (e.g., minimizes) effort required to develop and maintain permutations of screens required to support personalization and data privacy.

In an embodiment, a system (e.g., insurance and/or financial services software) may include security and dynamic entitlement features to promote data privacy and data integrity. In some embodiments, dynamic entitlement may include the ability to display a screen based on the user (i.e., the logged on user) to support group personalization rules and/or data privacy rules. Data privacy may be used to determine which business services are available to a given user. Any data element can be filtered from a response message based on the logged on user's security setting and the context within the current transaction. Data privacy may be used to determine which presentation services are available to a user. User logon and validation may verify that the user logging into the system is authorized to do so. Additionally, user ID may be used in data privacy rules processing. Dynamic entitlement may include rendering every page such that only the data entry and display fields available to the current user, as determined by the data privacy rules, are visible on the screen. This filtering may be transparent to the user in that the screen will not be noticeably missing fields (i.e., no gaps in field layout).

Dynamic entitlement may include the ability to control the update of any data element. In an embodiment, any data element may be tagged and checked as to its eligibility to be updated based on, for example: the logged-on user's security setting; context within the current transaction; and presence or lack of other elements in the request or response. In some embodiments, the user interface for any given user may be rendered specifically for that user. In certain embodiments, fields that a given user is not authorized to directly change may be rendered as read-only fields.

Dynamic entitlement may include the ability to control execution of any transaction. In an embodiment, execution of a transaction may be limited based on a logged on user's security setting. For example, user logon and validation may be used to verify that the user logging into the system is authorized to do so. The first screen viewed by a user logging into the system will be rendered to provide the user with only those functions and features of the system that the user is authorized to use. In certain embodiments, actions that a user is not authorized to execute may not be presented to the user (e.g., the user may be unaware that these actions are possible). Data integrity may be used to determine which presentation services are available to a user.

Dynamic entitlement may include the ability to tailor the user presentation to the current logged-on user and/or the current transaction context. As used herein, “context” generally refers to the reasons the user is initiating a request or why the requested information is being accessed. Dynamic entitlement may enhance efficiency of a system by allowing one set of logic to dynamically serve the needs of different user groups. For example, in an insurance claims processing embodiment, a consumer user group may have more limited access to data and/or processes than an independent agent user group. Dynamic rendering of the display for the consumer, however, may not indicate that data and/or processes are inaccessible (e.g., gaps may not be visible on the screen). In another example, a user group including independent agents from one state may have access to different policies than a user group including independent agents from another state. In another example, an administrative user group may be able to change characteristics of a policy that an independent agent user group has read-only access to.

In an embodiment, metadata may be provided to the presentation services based on a logged-on user's security setting. In some embodiments, metadata may be provided to the presentation services based on applicable support data and the rules governing the availability of the data. In some embodiments, the ability to provide dynamic screens with available actions and drop-down data entry fields with filtered data elements may be based on the security setting of a logged-on user. In some embodiments, the ability to provide dynamic screens with available actions and drop-down data entry fields with filtered data elements may be based on meta information describing the transaction and the accompanying message.

In some embodiments, security may be set up and/or managed from a single administrative console. In certain embodiments, a system may accept a request for security administration and provide a response to the request. This ability may allow a presentation services layer to interface and coordinate with a business services layer for setup and management of security. In some embodiments, a set of administrative screens may be provided to facilitate setup and management and security for a system. Controller logic behind the administrative screens may coordinate the setup of security between layers in a system (e.g., between a presentation services layer and a business services layer).

In some embodiments, a presentation services layer may allow an administrative user to highlight a field on a screen and set attributes for user groups, authority levels, and/or transaction context. Attributes for user groups may include, but are not limited to, hidden/visible; always read-only/default (driven by other rules); always required/default (driven by other rules); default value. In certain embodiments, an administrative interface may be provided to receive and process rules set by a user from the presentation services.

In an embodiment, security data may be communicated between layers by an XML response message. In an embodiment, all of the software logic associated with applying the security rules and settings may be encapsulated within a business services layer. The requesting presentation service layer may be responsible for making a request for a given service, including the identity of the user. The presentation service layer may be responsible for obtaining the end user's logon ID and password. In some embodiments, the presentation service layer may validate the user against security tables. Once validated, the user may be presented with a home page. The home page may serve as the root launching point for all activities available through the system. In certain embodiments, data (e.g., metadata) associated with the home page and subsequent screens may be provided by the requesting business service.

A business services requests may be a well-known XML message compatible with the ACORD standard. For example, the request of a personal auto policy's vehicle information may be written as:

<ACORD>

<SignonRq>

<SignonPswd>

<CustId>

<SPName />
<CustLogonId >jdoe</CustLogonId>

</CustId>
<CustPswd>

<CryptType />
<Pswd>123ABC</Pswd>

</CustPswd>

</SignonPswd >
<ClientDt />
<CustLangPref />
<ClientApp />

</SignonRq>
<InsuranceSvcReq>

<RqUID>11AB22C00345D6E7</RqUID>
<PersAutoVehicleInqRq>

<TransactionEffectiveDt>O1/O1/2001

<TransactionEffectiveDt/>

<PersPolicy>

<ItemIdInfo I>
<PolicyNumber>HP0123456

</PolicyNumber>

<LOBCd/>
<EffectiveDt>10/10/2000</EffectiveDt>
<ExpirationDt>10/10/2001 </ExpirationDt>
<Activity />
<QuoteInfo/>
<ControllingStateProvCd/>
<com.mynd.LatestTransactionDt />

</PersPolicy>

</PersAutoVehicleInqRq>

</InsuranceSvcReq>

<ACORD>

The business services layer receiving this request may fulfill the transaction requested by providing a response. The response may be an XML message. The response may be compatible with the ACORD document type definition. The response message may be built by executing smaller components that include logic from the business services layer and/or logic from the information systems layer. The response message may be assembled and returned to the presentation services layer.

Part of the process that assembles the response message includes execution of validation rules based on security setting for the user making the request. In some embodiments, the data privacy rules may be externalized for ease of customization. In some embodiments, the data privacy rules may be driven by context and unit of work. In certain embodiments, the data privacy rules may be driven by security information for the user. In some embodiments, the data privacy rules may physically filter all data elements from a response that are identified by the data privacy rules as being unavailable to the user. In certain embodiments, the data privacy rules may mark, through an indicator, elements impacted by the data privacy rules. The indicator may indicate whether the elements should be accessible or read-only based on the data privacy rules.

In some embodiments, data elements filtered from the response may be removed from the response XML message (e.g., the filtered data elements are not made available to the presentation services layer from the business services layer). In certain embodiments, data elements marked as being read-only may have a read-only attribute set in the response XML message. The presence of attributes in the response XML message may allow efficient operation of the presentation services layer by using implicit and explicit data provided in the XML response message to render appropriate user interfaces.

In some embodiments, the response message may be written as:

<ACORD>

<SignonRq>

<SignonPswd>

<CustId>

<SPName />
<CustLogonId >jdoe</CustLogonId>

</CustId>
<CustPswd>

<CryptType />
<Pswd>123ABC</Pswd>

</CustPswd>

</SignonPswd>
<ClientDt />
<CustLangPref />
<ClientApp />

</SignonRq>
<InsuranceSvcReq>

<RqUID>11AB22C00345D6E7</RqUID>
<PersAutoVehicleInqRs>

<TransactionEffectiveDt>01/01/2001

<TransactionEffectiveDt/>

<Status />
<PersPolicy>

<ItemIdInfo />
<PolicyNumber>HP0123456

</PolicyNumber>

<LOBCd/>
<EffectiveDt>10/10/2000</EffectiveDt>
<ExpirationDt>10/10/2001</ExpirationDt>
<Activity />
<QuoteInfo/>
<ControllingStateProvCd/>
<com.mynd.LatestTransactionDt />

</PersPolicy>
<PersAutoLineOfBusiness>

<LOBCd />

<PersVehicle>

<VehicleIdInfo>

<Manufacturer>Ford</Manufacturer>
<Model >Mustang</Model>
<ModelYear>1999</ModelYear>
<VehicleBodyTypeCd>CONV

</VehicleBodyTypeCd>

</VehicleIdInfo>
<CostNewAmt />
<Coverage>

<com.mynd.CountyCd>Richland

</com.mynd.CountyCd>

<com.mynd.VehicleTypeCd />
<com.mynd.FreeFormInd />
<com.mynd.PresentValueAmt readOnly
= “true”>18000.00

</com.mynd.PresentValueAmt>

<EffectiveDt/>

</Coverage>

</PersVehicle>

</LOBCd>

</PersAutoVehicleInqRq>

</InsuranceSvcReq>

<ACORD>

This response may be processed by the presentation services layer. In some embodiments, the processing may include breaking the InsuranceSvcReq element into smaller pieces if it is to be presented in more than one screen, as well as dynamically rendering the actual HTML that will be sent to the user's browser. The rendering of the HTML is where XSLT is utilized (e.g., to take advantage of the features of the XML response message). In certain embodiments, elements that have been filtered because of security rules may not be present to be processed by the XSLT. Thus, there may not be special logic in the presentation services layer to deal with the absence or presence of data. In some embodiments, the XML security metadata may be used by the XSLT to provide for read-only fields and available transactions.

In an embodiment, the security metadata XML messages may act as a defined interface to security, thus providing for flexibility in the implementation of the components that supply the security information. In some embodiments, components that supply the security information, or all of the information needed by the interface, may be implemented. In certain embodiments, metadata employed by the presentation services layer is presentation oriented and may describe how a screen looks and/or what types of graphical controls are used to house the different elements in the XML business message.

In some embodiments, security setup and administration may be accomplished through administrative screens provided by the presentation services layer. The administrative screens may hide any duplication of security required in the presentation services layer and the business services layer.

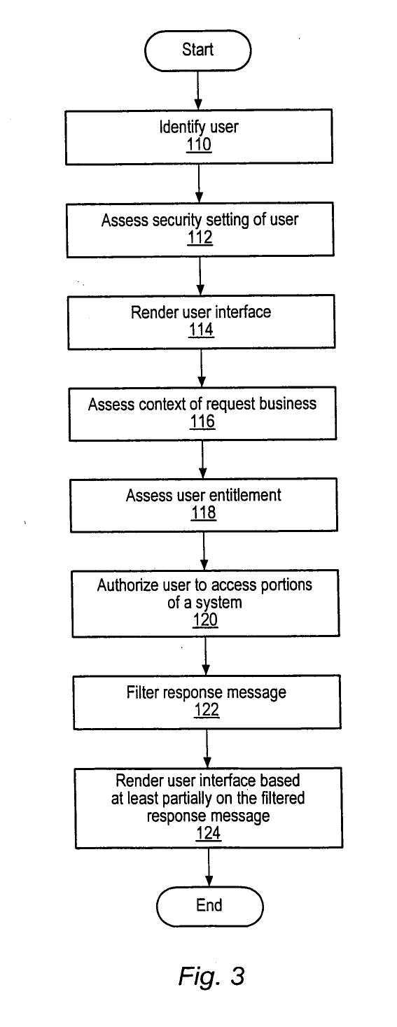

FIG. 3 illustrates an embodiment of a method of dynamically creating a user interface for a system. A user of the system may be identified 110. A security setting of the user may be assessed 112. A user interface (e.g., an initial screen) may be rendered 114 based at least partially of the security setting of the user. The user may initiate a business request (e.g., a transaction) based on the data and/or processes visible on the initial screen. Context of the business request may be assessed 1 16.

In some embodiments, user entitlement to data elements and/or features (e.g., processes) of the system may be dynamically assessed 118 based at least partially on the security setting of the user and the context of the transaction between the user and the system. After entitlement of the user has been assessed, the user may be authorized 120 to access data elements and/or features of the system based on the entitlement of the user. The system may generate a response message based on the user's request. In some embodiments, the response message may be filtered based at least partially on the authorization of the user 122. A user interface may be rendered based at least partially on the filtered response message 124.

Various embodiments may also include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, may be conveyed via a communication medium such as a network and/or a wireless link.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method for creating a user interface for a system, comprising:
identifying a user of the system;
assessing a security setting of the user;
assessing context within a transaction between the user and the system;
assessing entitlement of the user to portions of the system based at least partially on the security setting of the user and the context of the transaction between the user and the system;
authorizing the user to access portions of the system to which the user is entitled;
filtering a response message of the system based at least partially on the authorization of the user; and
rendering the user interface based at least partially on the filtered response message to allow the user to access one or more of the portions of the system that the user is authorized to access and to inhibit the user from accessing one or more of the portions of the system that the user is not authorized to access.

2. The method of claim 1, wherein identifying the user comprises identifying a role of the user.

3. The method of claim 1, wherein assessing entitlement of the user comprises dynamically assessing entitlement of the user.

4. (canceled)

5. The method of claim 1, wherein rendering the user interface comprises withholding one or more features of the system, wherein the user is not authorized to access each of the withheld features.

6-8. (canceled)

9. The method of claim 1, wherein rendering the user interface comprises dynamically changing a function of the user interface.

10. The method of claim 1, wherein rendering the user interface comprises limiting availability of one or more data elements of the system to the user.

11-12. (canceled)

13. The method of claim 1, wherein rendering the user interface comprises displaying one or more authorized data entry fields substantially without gaps.

14-15. (canceled)

16. The method of claim 1, wherein rendering the user interface comprises displaying one or more authorized display fields substantially without gaps.

17. (canceled)

18. The method of claim 1, wherein rendering the user interface comprises updating a data element of the system based at least partially on the user's security setting, the context within the transaction, and the presence or absence of one or more other data elements in a system response to a user request for information.

19-21. (canceled)

22. The method of claim 1, wherein rendering the user interface comprises displaying one or more read-only fields that the user is not authorized to access.

23-24. (canceled)

25. The method of claim 1, further comprising providing metadata to presentation services based at least partially on the user's security setting and applicable support data and rules governing availability of the support data.

26. (canceled)

27. The method of claim 1, further comprising providing a dynamic display with available actions and drop-down data entry fields with filtered data elements based at least partially on the user's security setting.

28. The method of claim 1, further comprising providing a dynamic display with available actions and drop-down data entry fields with filtered data elements based at least partially on metadata describing the transaction.

29-30. (canceled)

31. A method for creating a user interface for a system comprising:
accessing a website through a user system;
transmitting a security setting of a user via the website;
assessing entitlement of the user to access one or more portions of the system based at least partially on the security setting of the user; and
rendering a user interface based at least partially on the security setting of the user, wherein the user interface comprises one or more of the portions of the system the user is entitled to access, and wherein at least a portion of the system the user is not entitled to access is not viewable in the user interface.

32. The method of claim 31, further comprising assessing a context within a transaction between the user and the system, wherein the user interface is at least partially rendered based on the context of the transaction, and wherein the user interface is configured such that a transaction the user is not entitled to access is not viewable in the user interface.

33. The method of claim 31, wherein rendering the user interface comprises displaying one or more authorized data entry fields substantially without gaps.

34-40. (canceled)

41. A method for creating a user interface for a system comprising:
accessing a website through a user system;
transmitting a security setting of a user via the website;
assessing a context of a transaction between the user and the system;
assessing an entitlement of the user to access portions of the system based at least partially on the security setting of the user and the context of the transaction; and
rendering a user interface based at least partially on the security setting of the user and the context of the transaction, wherein the user interface is configured to allow the user to execute one or more actions the user is entitled to access, and wherein the user interface is configured to inhibit the user from executing one or more of the actions the user is not entitled to access.

42-43. (canceled)

44. The method of claim 41, further comprising providing a dynamic display with available actions and drop-down data entry fields with filtered data elements based at least partially on the user's security setting and the context of the transaction.

45. The method of claim 41, wherein rendering the user interface comprises displaying one or more read-only fields that the user is not authorized to access.

46. (canceled)

47. The method of claim 31, wherein the user can view a portion of the system that the user is not entitled to access, and wherein the user is inhibited from accessing portions of the system the user is not entitled to access.
